(19) United States
(12) Patent Application Publication
(10) Pub. No.: US 2008/0248337 A1
(43) Pub. Date: Oct. 9, 2008

(54) Power Plant Comprising Fuel Cells

(75) Inventor: Erik Middelman, Arnhem (NL)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: NedStack Holding B.V., Arnhem (NL)

(21) Appl. No.: 10/586,577

(22) PCT Filed: Jan. 20, 2005
(86) PCT No.: PCT/NL2005/000041

§ 371 Date: Jun. 16, 2008

(30) Foreign Application Priority Data
Jan. 20, 2004 (NL) 1025289

(51) Int. Cl. H01M 8/00

(52) U.S. Cl. 429/13; 429/12

(57) ABSTRACT

The invention relates to a power plant for generating electric power by means of fuel cells. The power plant is characterized by a nominal power amounting to less than 50% of the peak power, and preferably even less than 25% of the peak power. The power plant preferably comprises several hundred fuel cell stacks.

### CROSS-REFERENCE TO RELATED APPLICATION

This Application is a Section 371 National Stage Application of International Application No. PCT/NL2005/000041, filed Jan. 20, 2005 and published as WO 2005/069422 A1 on Jul. 28, 2005, in English.

### BACKGROUND OF INVENTION

The invention relates to a power plant for generating electric power by means of fuel cells.

The polymer electrolyte fuel cell, “Proton Exchange Membrane Fuel Cell” or “Solid Polymer Fuel Cell” (SPFC) is a type of fuel cell in which the electrolyte consists of a semi-permeable polymer membrane that only conducts hydrogen ions. The electrodes generally consist of carbon, which is only lightly plated with platinum, as a catalyst, and the current collectors consist of, successively, a hydrophobic gas-permeable carbon fibre paper and a gastight, grooved graphite plate, which seals the cell from the next cell in the stack. The whole typically operates at temperatures of 60 . . . 95° C. and energy densities of up to 0.7 W/cm² and has a electric efficiency of 45 . . . 65%, independently of the working point of the cell. On account of its low temperature, its long life, its small size and low cost, the SPFC is a suitable choice for converting fuel into electricity and heat.

Such polymer electrolyte fuel cells and fuel cell stacks are generally known, for example from publications such as: “Fuel cells in perspective and the fifth European framework programme” by Gilles Lequeux in the so-called proceedings of “The 3^{rd} International Fuel Cell Conference”.

Large-scale chemical and electrochemical processes, such as the production of chlorine and chlorates, require a great deal of electrical energy. Installed powers of up to 100 MW and higher for individual factories are not uncommon. In the production of chlorine and chlorates, hydrogen is released as a by-product. Said hydrogen can be converted into electric power by means of a fuel cell, which power is in turn utilised for the electrochemical production.

From U.S. Pat. No. 4,689,133 it is known that it is possible to couple a fuel cell and an electrolysis cell. A chlorine membrane electrolysis cell and a polymer electrolyte fuel cell are coupled, for example. The chlorine electrolysis cell produces chlorine and caustic, with hydrogen as a by-product. A saving on the consumption of electrical energy of up to about 20% can be realized by converting said hydrogen into electric power in the fuel cell and carrying it back to the chlorine electrolysis cell. From an economic viewpoint, this is an important advantage, because energy costs constitute more than 50% of the production costs. The coupling that is proposed in U.S. Pat. No. 4,689,133, with the associated control system, is useful, but it has a few drawbacks. The working points of the cells are directly coupled, this prevents conversion losses in the power electronics, but it renders the fuel cell unsuitable for supplying brief peak powers. In addition to that, the oxidant circulation proposed therein is unattractive from an energetic viewpoint if air is used as the oxidant. Another drawback of the system that is known from U.S. Pat. No. 4,689,133 is that the degradation characteristics of the fuel cell and partial electrolysis will lead to an increasing voltage mismatch. If the current remains constant, the voltage supplied by the fuel cell slowly decreases as time goes by, so that an increased voltage is required if the current level in the electrolysis cell remains constant.

Conventional power plants that make use of turbine technology have a number of drawbacks. The electrical efficiency is moderate at full load and low during operation at partial load. In addition to that, maintaining standby power is costly when turbines are used and the efficiency of these so-called “spinning reserves” is zero per cent. Furthermore, the response time is relatively long, which is a problem in the case of rapid load variations in the electric mains. An increasing share of renewable energy, such as wind energy and solar energy, in the overall installed generation capacity leads to an increased chance of rapid load variations and to an increased need for directly available reserve power.

The turbine technology has further drawbacks. When turbines are used, it is attractive for economic reasons to install large powers, because they require the lowest investment per unit of power. A consequence of this is that turbine units supply powers of up to a few hundred megawatt each. As a result, a lot of capacity is directly lost in the case of failures or major repairs. Because turbines are heavily loaded, the life span of critical components is limited to about 24,000 hours. After this period, the turbine, and thus a substantial part of the power plant, is put out of commission and critical components, such as turbine blades, are exchanged. Such a period of standstill for maintenance usually lasts five to six weeks.

### SUMMARY OF INVENTION

A system can be designed in which the aforesaid drawbacks of the current technology are obviated or at least alleviated. The power plant has a relatively high efficiency and a relatively large reserve power.

To that end, the power plant an installed peak power of the power plant that is more than twice, preferably more than three times higher than the average generated power.

### DETAILED DESCRIPTION OF ILLUSTRATIVE EMBODIMENTS

The fuel cell power plant comprises groups of cells connected in series, the so-called fuel cell stacks. Said stacks, or a number of said series-connected stacks, supply a DC voltage which, during normal operating conditions, corresponds to a voltage required for, for example, electrolysis cell stacks. In addition to that, the fuel cell stacks are coupled to the electric mains via one or more so-called inverters. The inverters supply an AC voltage back to the electric mains, which AC voltage is in phase with the electric mains. The fuel cell and the associated system components have been designed for operation at partial load. The efficiency level of the fuel cell is highest and the life span is longest when the fuel cell can operate at partial load. However, the fuel cell system is preferably also capable of supplying a considerably higher power, i.e. a power two to six times higher than the power that is normally supplied at partial load.

The power plant is preferably fully modular and comprises one or more fuel cell generator modules, which in turn comprise two or more fuel cell stacks. The stacks themselves, too, are preferably modular and comprise a large number, up to a few hundred, mostly identical cells. The fuel cell stacks typically each have a power ranging between 1 and 1000 Kw, preferably a power ranging between 10 and 250 Kw, at least when used in a power plant. For example, a power plant having a power of e.g. 200 MW might comprise 2000 fuel cell stacks each having a power of 100 Kw. This has a number of important advantages in comparison with conventional turbine plants.

It is possible in the fuel cell power plant to gradually install more and more power by placing additional fuel cell stacks. Preferably, the total installation time of the fuel cell corresponds to the life span of the individual fuel cell stacks. Another advantage of the modular structure is the fact that it is possible to compensate for the decreasing cell voltage caused by fuel cell degradation and for the increasing voltage required by the electrolysis cell as a result of said degradation by adding stacks or stack modules.

### EXAMPLE 1

A fuel cell power plant to be built has a peak power of 200 MW and a power of 200 MW at partial load. The complete plant will consist of 2000 fuel cell stacks, each having a peak power of 100 kW. In this example, the stacks are arranged in modules of 200 stacks. The life span of the fuel cells is typically 5 years, and after 5 years' operation the fuel cell stacks are exchanged.

In year 1, a first module comprising 200 stacks is placed, and subsequently a 2^{nd} module comprising 200 stacks. Thus, 40 MW of peak power is annually installed. When the power plant has 200 MW of installed power after 5 years, the stacks that were installed first approach the end of their life cycle and need to be exchanged. Said stacks can be exchanged one by one without having to put the power plant or even the module in question out of commission.

At no time will it be necessary to put the entire power plant out of commission in the case of failures or maintenance, but it is possible to exchange individual fuel cells. The modular fuel cell power plant exhibits a high degree of reliability, because it comprises hardly any moving parts. Failure of a few stacks will hardly affect the supplied power, if at all, since the percentage is small in relation to the rated power and a much higher power is available at all times.

### EXAMPLE 2

In a fuel cell power plant having a peak power of 200 MW, a nominal power of 50 MW and 2000 fuel cell stacks, 20 fuel cell stacks fall out of action because of a failure. The control system is set in such a manner that the plant will continue to supply 50 MW.

In such a case the fuel cells that have fallen out of action are switched off, the supply of hydrogen and air is stopped and the stacks are electrically disconnected.

The plant still has 1980 stacks in operation, therefore. Since fewer stacks must supply the same power, the power density in the cells, and consequently also the power density per cell, needs to increase. A direct consequence of this is that the cell voltage slightly decreases. For example, it decreases from 0.78 V/cell to 0.775 V/cell. As a result, the electric efficiency of the plant decreases by about 0.5% from 61% to 60.5%. The stacks can be disconnected without interrupting the power supply and be exchanged for spare stacks.

At partial load, the electric efficiency of the fuel cell is considerably higher than at full load. At partial load, the efficiency level is generally slightly higher than 60%, whilst it decreases to a level below 45% at full load. In addition to that, the life span of the fuel cell is considerably longer in the case of operation at partial load. The fuel cell power plant is therefore preferably designed for operation at partial load. The reserve capacity thus installed can be directly put into service in that case. The response time for switching from partial load to full load is less than a second for the fuel cell stack. In order to be able to actually utilise this peak power for a prolonged period of time (longer than a few seconds), the other system components must be suitable for this purpose, too. The other components in the system are, amongst other components: the hydrogen supply system, the air supply system, the air humidification system, the hydrogen conditioning system and the cooling system.

### EXAMPLE 3

Due to degradation of the fuel cell, the cell voltage decreases by 10% over a period of 10.000 hours. As a result, the voltage of the fuel cell stack and the fuel cell module decreases as well if the current consumption remains constant. Due to degradation of the electrolysis cell, the efficiency level decreases as time goes by. Since the amount of current consumed is proportional to the amount of current produced in this process, it is preferred to maintain a constant current level. To realize this, the cell voltage and thus the voltage of the electrolysis stack must increase. In this example, said increase is 1 per 1000 hours. A fuel cell module consisting of 4 parallel-connected strings of 10 series-connected stacks is directly coupled to an electrolysis cell, it supplies 10*60 V=600 V to the electrolysis cell with a current of 1000 A. After 1000 hours, the fuel cell voltage has decreased by about 1%, which equals 6V. The voltage that the electrolysis cell requires has increased by 1% during the same period. In order to be able to continue to supply the required current to the electrolysis cell, this must be compensated by increasing the output voltage of the fuel cell module. This takes place by adding more stacks. After 1000 hours, for example, 4 stacks having a voltage of 12 V, one 12 V stack per string, are added. Owing to the modularity of the system, it is possible in this way to compensate for degradation without advanced power electronics being required. Direct DC-DC coupling between the electrolysis cell and the fuel cell suffices.

The value of the standby power of the fuel cell may be higher than that of the power that is actually produced by the fuel cell. To be able to utilise this value, a stock of hydrogen is required. The storage of hydrogen is a technique that is known per se. It can take place in liquid condition at very low temperatures, at a high pressure in cylinders, or substantially at atmospheric pressure in large gas holders or balloons. The hydrogen in said buffer stocks can be supplied by electrolysis of water or a sodium chloride solution, for example, by reforming hydrocarbons or carbon followed by a purification step, or by other known hydrogen production techniques.

The invention is not limited to the embodiments as described above, which can be varied within the scope of the invention as defined in the claims. Thus, the power plant may comprise one or more turbines or other generators which are responsible for at least part of the average generated power, whilst fuel cells are utilised for realising a relatively high installed peak power.

1. A power plant for generating electric power comprising fuel cells, wherein the installed peak power of the power plant is more than two times higher than the average generated power.

2. The power plant according to claim 1, wherein the power plant comprises more than ten fuel cell stacks.

3. The power plant according to claim 1, which is coupled to an electrochemical production process in which hydrogen is released, and which is arranged for generating electric power, using at least part of said hydrogen, and supplying at least part of the generated electric power to the electrochemical production process.

4. The power plant according to claim 3, wherein the fuel cell stacks are connected in strings, and wherein the voltage of said strings at least substantially corresponds to the DC voltage that is required in the electrochemical process.

5. The power plant according to claim 2, wherein the installation time of the fuel cells in the power plant at least substantially corresponds to the life span of the fuel cell stacks.

6. The power plant according to claim 1, wherein the fuel cells are arranged such that at least some of the fuel cells are exchangeable without switching off other fuel cells that are operating.

7. A method for generating electric power, comprising:
using a power plant for generating electric power comprising fuel cells, wherein the installed peak power of the power plant is more than two times higher than the average generated power;
supplying at least part of the generated power to an electrochemical process in which hydrogen is released; and
utilizing at least part of said hydrogen by the power plant for generating electric power.

8. The method according to claim 7, and further comprising adding series-connected fuel cell stacks to increase the DC voltage supplied by the power plant such that the current in the electrochemical process is maintained at an at least substantially constant level.

9. The method according to claim 7, and further comprising maintaining current in the electrochemical process, at an at least substantially constant level through the addition of parallel-connected fuel cell stacks.

10. The power plant according to claim 2, which is coupled to an electrochemical production process in which hydrogen is released, and which is arranged for generating electric power, using at least part of said hydrogen, and supplying at least part of the generated electric power to the electrochemical production process.

11. The power plant according to claim 1, wherein the power plant comprises more than a hundred fuel cell stacks.

12. The power plant according to claim 11, which is coupled to an electrochemical production process in which hydrogen is released, and which is arranged for generating electric power, using at least part of said hydrogen, and supplying at least part of the generated electric power to the electrochemical production process.
